(19) United States
(12) Patent Application Publication
(10) Pub. No.: US 2009/0153467 A1
(43) Pub. Date: Jun. 18, 2009

(54) System and method for connection detection

(76) Inventor: Robert Crovella, Prosper, TX (US)

Correspondence Address: MURABITO HAO & BARNES LLP, Third Floor, Two North Market Street, San Jose, CA, 95113, US

(21) Appl. No.: 12/002,075

(22) Filed: Dec. 14, 2007

(51) Int. Cl. G09G 5/00

(52) U.S. Cl. 345/156

(57) ABSTRACT

A system and method for detecting a display connection. The system includes a transmitter operable to be coupled to a receiver. The transmitter includes a controller operable to generate a connect signal when the receiver is coupled to the controller and is further operable to generate a disconnect signal when the receiver is uncoupled from the controller. The transmitter further includes a detection component operable to detect the connect signal and is further operable to detect the disconnect signal.

### FIELD OF THE INVENTION

The present invention is generally related to connection detection.

### BACKGROUND OF THE INVENTION

As computer technology has advanced, computers have gone through an extensive growth and development process. In some cases, technologies such as display (e.g., monitors) have started out relying largely on analog technology. As a result, today many monitors have both analog and digital inputs. Correspondingly, video cards have both analog and digital outputs. Modem monitors are able to communicate their capabilities to a computer system via an Extended Display Identification Data (EDID).

A problem however arises in relying on the EDID, a display which has both analog and digital inputs may return the same EDID regardless of which connection is driving the display. For example, a computer can be connected to the analog input of the monitor via a cable that supports both digital and analog. The computer system may then receive an EDID containing information that the display device is a digital display device. The computer system in response may drive a digital output of the computer system causing the screen to go blank. This is particularly problematic because there is no way to recover the display output without another monitor or cable. Attempting to reboot the computer will not fix the problem because the computer system will again get a digital EDID signal and drive the digital output.

One such solution to this problem is to favor an analog connection and ignore the EDID. The computer system will first detect the presence of an analog connection and drive the analog output. A digital output will only be driven if the analog connection is not detected. If a cable supports both digital and analog, then the analog connection will be used. Unfortunately, this solution is not adequate because digital connections are preferred based on providing better output quality.

Thus, a need exists for a way to detect a digital display connection. Once a digital connection is detected, a digital output can be driven.

### SUMMARY OF THE INVENTION

Embodiments of the present invention provide a solution for detecting a digital connection. Embodiments of the present invention further can detect the integrity of a digital connection.

In one embodiment, the present invention is implemented as a system for detecting a display connection. The system includes a transmitter including a controller operable to generate a connect signal when the receiver is coupled to the controller and is further operable to generate a disconnect signal when the receiver is uncoupled from the controller. The transmitter further includes a detection component operable to detect the connect signal and is further operable to detect the disconnect signal. The system may enable a digital output if a connect signal is detected.

In another embodiment, the present invention is implemented as a method for detecting a display connection. The method includes sampling a sense line. In response to receiving the sampling, a connected signal is generated when a transmitter (e.g., computer system) is coupled to a display (e.g., computer monitor or television). Also, in response to receiving the sampling, a disconnected signal is generated when a transmitter is uncoupled from a display. In response to the signal generation, a detection is performed as to whether the connected signal or the disconnected signal was generated. If the connected signal was generated a digital output may be enabled.

In this manner, embodiments of the present invention implement a reliable way for detecting a display connection. Thus, a digital output can be driven with confidence that a digital cable is connected. Embodiments further provide for ensuring integrity (e.g., no break or bad connections) of a display connection (e.g., cable).

In another embodiment, the present invention is implemented as a graphics processing unit (GPU). The GPU includes a plurality of pipelines for facilitating graphics processing and an interface for coupling the GPU to a computer system. The GPU further includes a plurality of output connectors for coupling the GPU to a display device and a circuit for detecting a digital connection via at least one of the output connectors coupled to the GPU. The circuit includes a controller operable to generate a connect signal when a receiver is coupled to the controller and is further operable to generate a disconnect signal when the receiver is uncoupled from the controller. The circuit further includes a detection component operable to detect the connect signal and is further operable to detect the disconnect signal. The GPU may enable a digital output if a connect signal is detected.

### BRIEF DESCRIPTION OF THE DRAWINGS

The present invention is illustrated by way of example, and not by way of limitation, in the figures of the accompanying drawings and in which like reference numerals refer to similar elements.

FIG. 1 shows a computer system in accordance with one embodiment of the present invention.

FIG. 2 shows a block diagram of an exemplary operating environment in accordance with one embodiment of the present invention.

FIG. 3 shows a block diagram of an exemplary graphics processing unit in accordance with one embodiment of the present invention.

FIG. 4 shows an exemplary circuit for detecting a connection in accordance with one embodiment of the present invention.

FIG. 5 shows a flowchart of a process for detecting a connection in accordance with one embodiment of the present invention.

### DETAILED DESCRIPTION OF THE INVENTION

Reference will now be made in detail to the preferred embodiments of the present invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail as not to unnecessarily obscure aspects of the embodiments of the present invention.

### Notation and Nomenclature:

Some portions of the detailed descriptions, which follow, are presented in terms of procedures, steps, logic blocks, processing, and other symbolic representations of operations on data bits within a computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

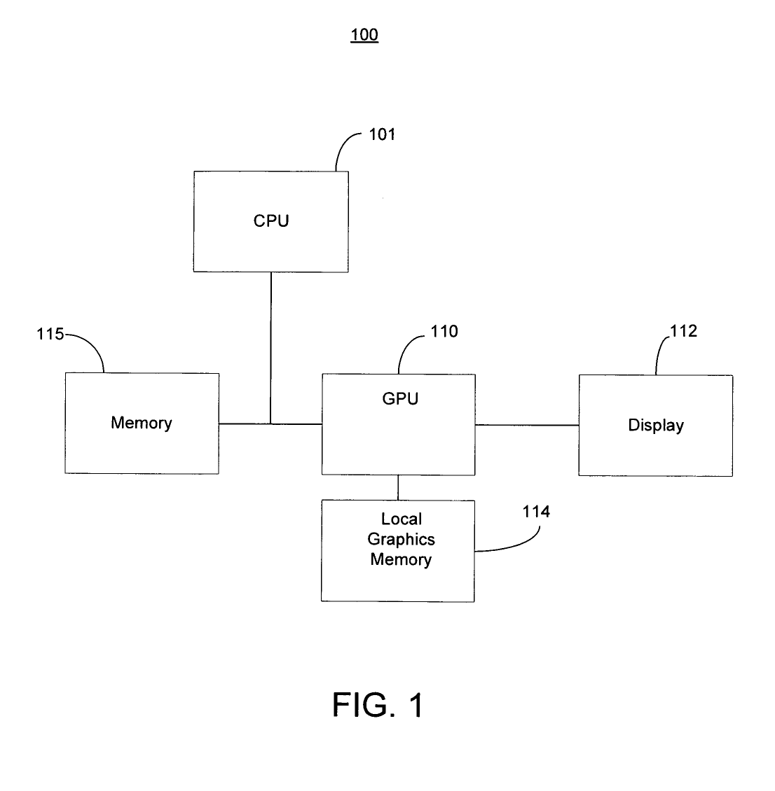

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “accessing” or “executing” or “storing” or “rendering” or the like, refer to the action and processes of a computer system (e.g., computer system 100 of FIG. 1), or similar electronic computing device, that manipulates and transforms data represented as physical (electronic) quantities within the computer system's registers and memories into other data similarly represented as physical quantities within the computer system memories or registers or other such information storage, transmission or display devices.

### Computer System Platform:

FIG. 1 shows a computer system 100 in accordance with one embodiment of the present invention. Computer system 100 depicts the components of a basic computer system in accordance with embodiments of the present invention providing the execution platform for certain hardware-based and software-based functionality. In general, computer system 100 comprises at least one CPU 101, a system memory 115, and at least one graphics processor unit (GPU) 110. The CPU 101 can be coupled to the system memory 115 via a bridge component/memory controller (not shown) or can be directly coupled to the system memory 115 via a memory controller (not shown) internal to the CPU 101. The GPU 110 is coupled to a display 112. One or more additional GPUs can optionally be coupled to system 100 to further increase its computational power. The GPU(s) 110 is coupled to the CPU 101 and the system memory 115. The GPU 110 can be implemented as a discrete component, a discrete graphics card designed to couple to the computer system 100 via a connector (e.g., AGP slot, PCI-Express slot, etc.), a discrete integrated circuit die (e.g., mounted directly on a motherboard), or as an integrated GPU included within the integrated circuit die of a computer system chipset component (not shown). Additionally, a local graphics memory 114 can be included for the GPU 110 for high bandwidth graphics data storage.

The CPU 101 and the GPU 110 can also be integrated into a single integrated circuit die and the CPU and GPU may share various resources, such as instruction logic, buffers, functional units and so on, or separate resources may be provided for graphics and general-purpose operations. The GPU may further be integrated into a core logic component. Accordingly, any or all the circuits and/or functionality described herein as being associated with the GPU 110 can also be implemented in, and performed by, a suitably equipped CPU 101. Additionally, while embodiments herein may make reference to a GPU, it should be noted that the described circuits and/or functionality can also be implemented and other types of processors (e.g., general purpose or other special-purpose coprocessors) or within a CPU.

System 100 can be implemented as, for example, a desktop computer system or server computer system having a powerful general-purpose CPU 101 coupled to a dedicated graphics rendering GPU 110. In such an embodiment, components can be included that add peripheral buses, specialized audio/video components, 10 devices, and the like. Similarly, system 100 can be implemented as a handheld device (e.g., cellphone, etc.), direct broadcast satellite (DBS)/terrestrial set-top box or a set-top video game console device such as, for example, the Xbox®, available from Microsoft Corporation of Redmond, Wash., or the PlayStation3®, available from Sony Computer Entertainment Corporation of Tokyo, Japan. System 100 can also be implemented as a “system on a chip”, where the electronics (e.g., the components 101, 115, 110, 114, and the like) of a computing device are wholly contained within a single integrated circuit die. Examples include a hand-held instrument with a display, a car navigation system, a portable entertainment system, and the like.

Embodiments of the present invention implement a reliable way for detecting a display connection. Thus, a digital output can be driven with confidence that a digital cable is connected. Embodiments further provide for ensuring integrity (e.g., no break or bad connections) of a display connection (e.g., cable).

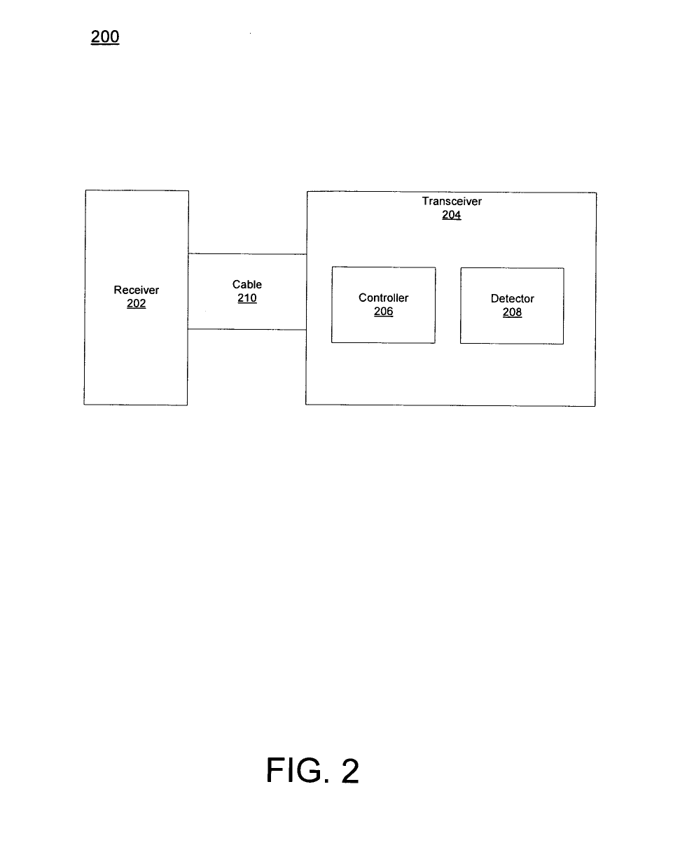

FIG. 2 shows a block diagram of an exemplary operating environment in accordance with one embodiment of the present invention. In one embodiment, operating environment includes a transceiver 204 for detecting a digital display connection. Operating environment 200 includes receiver 202, cable 210, and receiver 204. Receiver 204 is operable to display content and includes, but is not limited to, computer monitors (e.g., liquid crystal displays (LCDs)) and digital televisions (e.g., LCD, Plasma, and projection televisions). In one embodiment, transceiver 204 includes controller 206 and detector 208.

Transceiver 204 is operable to be coupled to receiver 202 via cable 210. It is appreciated that cable 210 could be a variety of cables including, but not limited to, Digital Visual Interface (DVI), High-Definition Multimedia Interface (HDMI), and other Transition Minimized Differential Signaling (TMDS) display technologies.

In one embodiment, controller 206 may be operable to generate a connect signal when receiver 202 is coupled to controller 206. Controller 206 may be further operable to generate a disconnect signal when receiver 202 is uncoupled from controller 206. The connect signal may be generated in response to a pull up to a power supply level. This disconnect signal may be generated in response to the absence of a pull up to a power supply level. In one exemplary embodiment, controller 206 may include, but is not limited to, a transistor, switch, and/or a plurality of resistors.

In one exemplary embodiment, controller 206 is part of (or included in) a graphics processing unit (GPU). In another embodiment, controller 206 is included on a video card. It is appreciated that controller 206 may be located anywhere as long as controller 206 is coupled to signal lines of cable 210.

In one embodiment, detection component 208 may be operable to detect the connect signal and may be further operable to detect the disconnect signal. In one embodiment, a digital output is selectively enabled in response to detection component 208 detecting the connect signal.

In one exemplary embodiment, detection component 208 is coupled to a register. Detection component 208 may further be coupled to a comparator which may compare the output of the detect component to a reference signal. Based on detection of the connect signal, a digital output may be enabled.

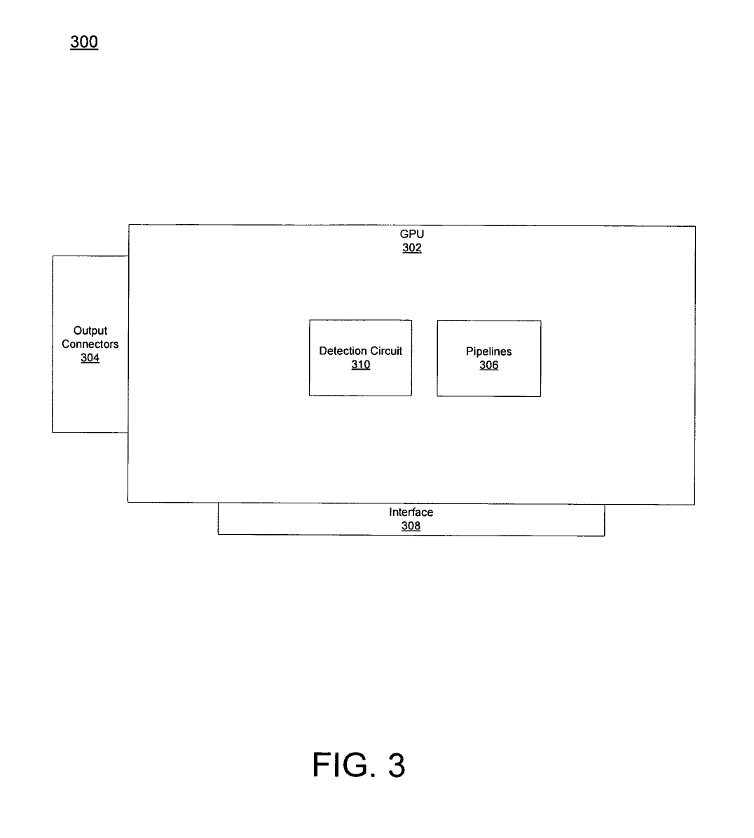

FIG. 3 shows a block diagram of an exemplary graphics processing unit (GPU) in accordance with one embodiment of the present invention. GPU 302 includes plurality of pipelines 306, interface 308, output connectors 304, and detection circuit 310.

Interface 308 is operable to couple GPU 302 to a computer system (e.g., system 100). Pipelines 306 includes a plurality of pipelines and facilitates graphics processing (e.g., 3D graphics processing) and may receive graphics data via interface 308. Plurality of output connectors 304 is operable to couple GPU 302 to drive a display device (e.g., display 112 or receiver 202) and may be used to output graphics data (e.g., processed by pipelines 306). Output connectors 304 may be a variety of connectors including, but not limited to, DVI, HDMI, and other TMDS display technology.

In one embodiment, detection circuit 310 detects a digital connection via at least one of output connectors 304 coupled to GPU 302. In one exemplary embodiment, detection circuit 310 is coupled to at least one signaling wire of output connectors 304. More specifically, detection circuit 310 may detect if a valid digital connection exists between a monitor and GPU 302. If a digital connection exists, then GPU 302 can enable a digital output mode on output connectors 304. GPU 302 may further check if an EDID contains information that a coupled monitor is a digital monitor prior to enabling the digital output.

In one embodiment, detection circuit 310 can be fabricated on a video card. For example, detection circuit 310 may connect to a GPU output line directly at the point to which the signal enters the cable connected to output connectors 304. It is further appreciated that detection circuit 310 may be fabricated anywhere as long as detection circuit 310 is coupled to a signal connection of output connectors 304.

In one embodiment, detection circuit 310 is coupled to a register on the GPU or other input so that a computer system can determine if a cable is present or not. For example, the register may be read by software which then enables digital output. The register could have a bit which is one if a digital cable is present and zero if a digital cable is not present. The determination of one or zero may be a function of the voltage detected by detection circuit 310 (e.g., 3.3V or ground).

In one embodiment, detection circuit 310 includes a controller and a detection component. The controller may be operable to generate a connect signal when a receiver is coupled to the controller. The controller may be further operable to generate a disconnect signal when the receiver is uncoupled from the controller. The connect signal may be generated in response to a pull up to a power supply level. This disconnect signal may be generated in response to the absence of a pull up to a power supply level. In one exemplary embodiment, the controller may include, but is not limited to, a transistor, switch, and/or a plurality of resistors.

In one embodiment, the detection component may be operable to detect the connect signal and may be further operable to detect the disconnect signal. In one embodiment, a digital output is selectively enabled in response to detection by the component detecting the connect signal.

In one exemplary embodiment, the detection component is coupled to a register. The detection component may further be coupled to a comparator which may compare the output of the detect component to a reference signal. Based on detection of the connect signal, a digital output may be enabled.

In another embodiment, GPU 302 is part of a high reliability or rugged system. GPU 302 may include a plurality of detection circuits 310 which are coupled to a plurality of wires of at least one output connector of output connectors 304. Such a configuration allows GPU 302 or a computer system to detect if there are any breaks or weak connections in a cable coupled to GPU 302. For example, a DVI cable may use three or six wire pairs to carry video output; a detection circuit 310 may be coupled to each of the wires of the three or six wire pairs. The plurality of detect signals from each detection circuit 310 may then be coupled to a register or other input device as described herein.

In one exemplary embodiment, the detection of broken cables may be part of a diagnostics process. For example, military systems or aircraft may run diagnostics upon power up or in real time to ensure integrity between the system and a display device.

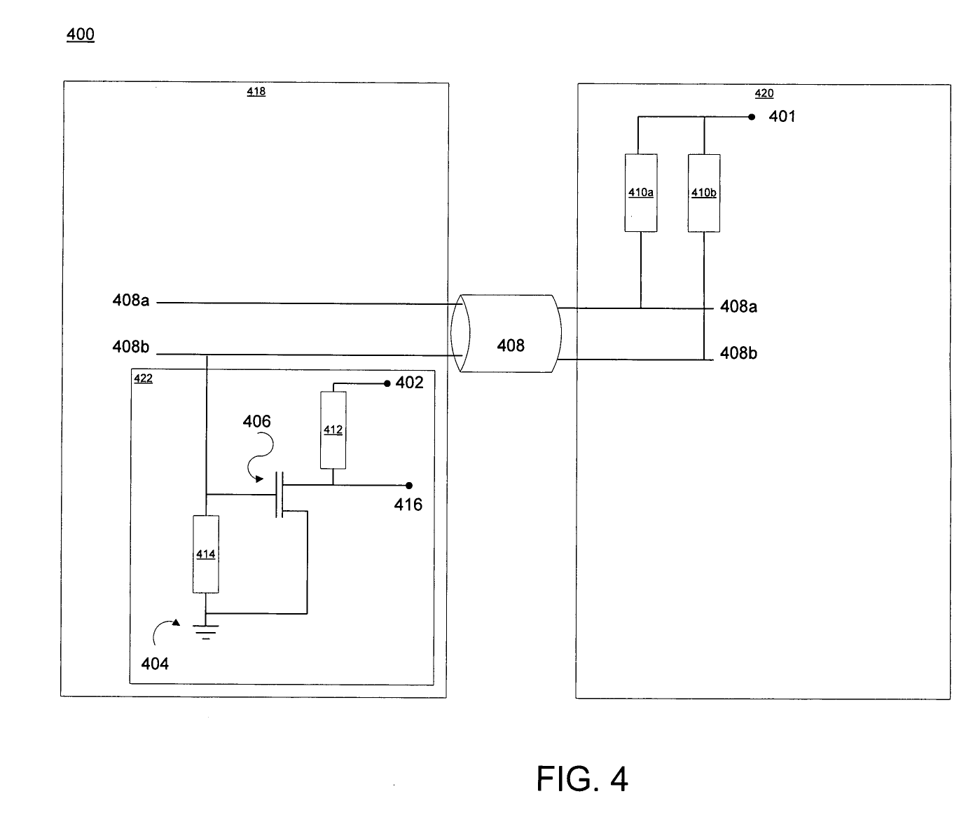

FIG. 4 shows an exemplary circuit for detecting a connection in accordance with one embodiment of the present invention. Circuit 422 outputs a signal corresponding to whether a receiver 420 (e.g., display device) is digitally coupled to a transceiver 418 (e.g., system 100).

Circuit 422 may be coupled to a single wire or sense line (e.g., 408a or 408b) of cable 408. Cable 408 may be a variety of cables including, but not limited to, DVI, HDMI, or other TMDS display technologies. Circuit 422 may reside on a GPU, video card, or anywhere circuit 422 may be coupled to a wire (e.g., 408a and/or 408b) of cable 408.

In one embodiment, circuit 422 includes resistors 412 and 414, transistor 406, ground 404, Vcc 402, and output signal 416. Circuit 422 may further include an inverter or a comparator (e.g., to compare output to a reference signal). Resistor 412 may be a pull up resistor and resistor 414 may be a high impedance pull down resistor. Vcc 402 may be a power supply rail on a GPU (e.g., GPU 302). Transistor 406 may be a metal oxide semiconductor field effect transistor (MOSFET) or switch. It is appreciated that transistor 406 may be any type of transistor or construction (e.g., PMOS or NMOS).

In one embodiment, circuit 422 is coupled to a receiver 420 designed and operating consistent with DVI specifications (e.g., Digital Display Working Group (DDWG) Digital Visual Interface specification 1.0). Receiver 420 is coupled to signal lines 408a and 408b which are used to drive the display and are coupled to pull up resistors 410a and 410b (e.g., 50 ohms) to a defined voltage AVcc 401 (e.g., 3.3V). Thus, when receiver 420 is powered on, signal lines 408a and 408b will have a voltage (e.g., 3.3V).

When a signal line (e.g., 408b) coupled to circuit 422 has a voltage or high voltage (e.g., 3.3V), transistor 406 turns on which causes output signal 416 to be pulled to ground 404. Similarly, when a signal line (e.g., 408b) has no or low voltage (e.g., unconnected), transistor 406 is off and output signal 416 is pulled up to Vcc 402 (e.g., 3.3V). It is appreciated that no or a low voltage could correspond to a broken or weak connection.

In one embodiment, detect signal 416 is latched into a flipflop or register where software can access the value (e.g., in response to an interrupt) and determine whether a digital cable is present and accordingly enable a digital output. For example, if a high voltage on a signal line may correspond to a one (e.g., cable connected) and a low voltage correspond to a zero (e.g., no cable connected).

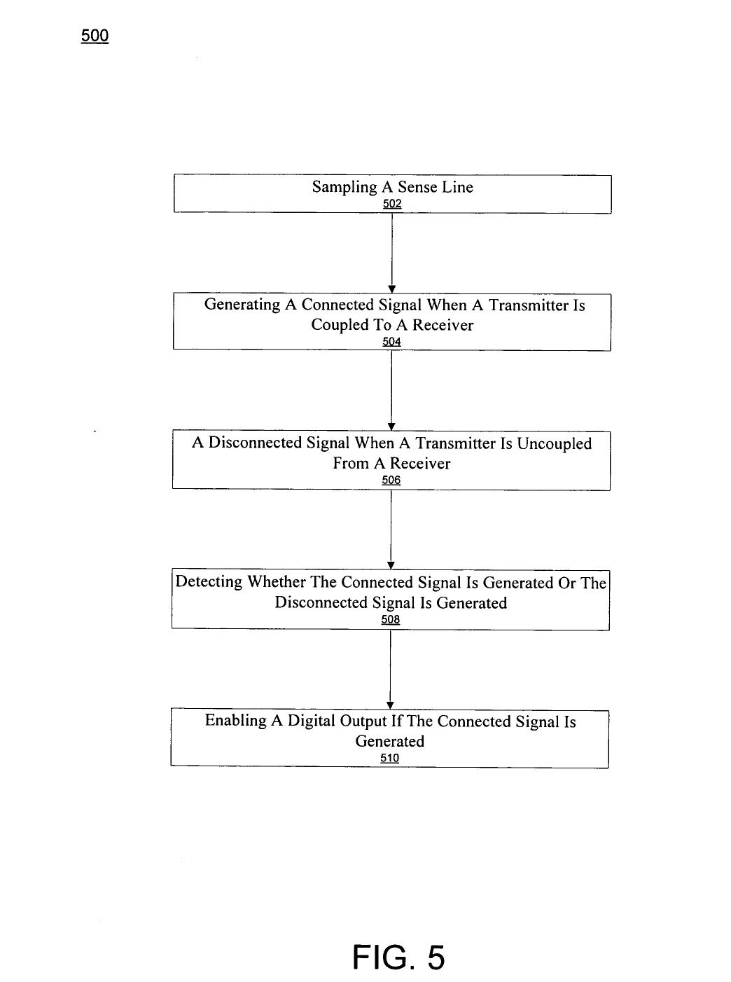

The following discussion sets forth in detail the operations of the present technology for network communication management. With reference to FIG. 5, flowchart 500 illustrates example blocks used by various embodiments of the present technology. Flowchart 500 includes processes that, in various embodiments, are carried out by a processor under the control of computer-readable and computer-executable instructions. Although, specific blocks are disclosed in flowchart 500, such blocks are examples. That is, embodiments are well suited to performing various other blocks or variations of the blocks recited in flowchart 500. It is appreciated that the blocks in flowchart 500 may be performed in an order different than presented, and that not all of the blocks in flowchart 500 may be performed.

FIG. 5 shows a flowchart of a process for detecting a connection to a display in accordance with one embodiment of the present invention. It is appreciated that the process flowchart 500 may be performed on one or more wires of a cable (e.g., a plurality of the wires within a DVI cable).

At block 502, a sense line (e.g., 408b) is sampled. In one embodiment, a signal (e.g., 3.3V or OV) may be sampled via a display (e.g., computer monitor or television). The signal may be based on a coupling of a variety of cables including, but not limited to, DVI, HDMI, or other TMDS display technologies.

At block 504, in response to the sampling, a connected signal is generated when a transmitter (e.g., computer system) is coupled to the display. In one embodiment, the connected signal may be OV or ground based on a signal sampled on a sense line of a cable.

At block 506, in response to receiving the sampling, a disconnected signal is generated when the transmitter is uncoupled to transmitter. In one embodiment, the disconnected signal may be 3.3V.

At block 508, in response to the generating, whether the connected signal or the disconnected signal was generated is detected. The detection may be based on a voltage detection (e.g., of 3.3V or ground) and may set the value of a register. The register may then be read by software. In one embodiment, the detection is based on comparing a reference signal to the generated signal (e.g., connected or disconnected signal).

At block 510, a digital output is enabled if the connected signal is generated. In one embodiment, the digital output is enabled based on the value of a register which was set based on the detection of the connected signal.

The foregoing descriptions of specific embodiments of the present invention have been presented for purposes of illustration and description. They are not intended to be exhaustive or to limit the invention to the precise forms disclosed, and many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A graphics system for detecting a digital display connection to a receiver comprising:
a transmitter operable to be coupled to said receiver, where said transmitter comprises:
a controller operable to generate a connect signal when said receiver is coupled to said controller and wherein said controller is further operable to generate a disconnect signal when said receiver is uncoupled from said controller; and
a detection component operable to detect said disconnect signal and wherein said detection component is further operable to detect said connect signal and wherein a digital output is selectively enabled in response to said detection component detecting said connect signal.

2. The system of claim 1 wherein said receiver is coupled to said transmitter via a Digital Visual Interface (DVI).

3. The system of claim 1 wherein said receiver is coupled to said transmitter via a High-Definition Multimedia Interface (HDMI).

4. The system of claim 1 wherein said connect signal is generated in response to a pull up to a power supply level.

5. The system of claim 1 wherein said disconnect signal is generated in response to the absence of a pull up to a power supply level.

6. The system of claim 1 wherein said detection component is coupled to a register for access by software operable to enable a digital output.

7. The system of claim 1 wherein said controller comprises a transistor for generating said connect signal and for generating said disconnect signal.

8. The system of claim 1 wherein said controller is part of a graphics processing unit (GPU).

9. The system of claim 1 wherein said controller is included on a video card.

10. A method for detecting a display connection to a display, comprising:
sampling a sense line;
in response to said sampling, generating a connected signal when a transmitter is coupled to said display;
in response to said sampling, generating a disconnected signal when a transmitter is uncoupled from a display;
in response to said generating, detecting whether said connected signal is generated or said disconnected signal is generated; and
enabling a digital video output if said connected signal is generated.

11. A method as described in claim 10 wherein said detecting comprises comparing a reference signal to said connected signal or said disconnected signal.

12. A method as described in claim 10 wherein said transmitter is coupled to said receiver via a HDMI cable.

13. A method as described in claim 10 wherein said transmitter is coupled to said receiver via a DVI cable.

14. A method as described in claim 13 wherein said connected signal is generated based on coupling of a plurality of circuits to each of a plurality of wires within said DVI cable.

15. A method as described in claim 10 wherein said enabling is based on access to a register.

16. A method as described in claim 10 wherein said detecting is performed by a GPU.

17. A GPU (graphics processor unit) comprising:
a pipeline for facilitating graphics processing;
an interface for coupling said GPU to a computer system;
a plurality of output connectors for coupling said GPU to a display device; and
a circuit for detecting a digital connection via at least one of said output connectors coupled to said GPU, wherein said circuit comprises:
a controller component operable to generate a connect signal when said receiver is coupled to said controller and wherein said controller is further operable to generate a disconnect signal when said receiver is uncoupled from said controller; and
a detection component operable to detect said disconnect signal and wherein said detection component is further operable to detect said
connect signal and wherein a digital output is selectively enabled in response to said detection component detecting said connect signal.

18. A GPU as described in claim 17 wherein said digital connection is a DVI connection.

19. A GPU as described in claim 17 wherein said digital connection is a HDMI connection.

20. A method as described in claim 19 wherein said circuit detects a digital connection on all wires within said HDMI cable.
